(19) United States
(12) Patent Application Publication
(10) Pub. No.: US 2015/0006811 A1
(43) Pub. Date: Jan. 1, 2015

(54) STORAGE DEVICE, ELECTRONIC APPARATUS, CONTROL METHOD OF STORAGE DEVICE, AND CONTROL PROGRAM FOR STORAGE DEVICE

(71) Applicant: KABUSHIKI KAISHA TOSHIBA, Tokyo (JP)

(72) Inventor: Keiichi Uehara, Ome-shi (JP)

(73) Assignee: KABUSHIKI KAISHA TOSHIBA, Tokyo (JP)

(21) Appl. No.: 14/162,284

(22) Filed: Jan. 23, 2014

(30) Foreign Application Priority Data
Jun. 28, 2013 (JP) 2013-137223

(51) Int. Cl. G06F 12/08

(52) U.S. Cl. CPC G06F 12/0866
USPC 711/113

(57) ABSTRACT

According to one embodiment, a storage device includes: a first storage module configured to detect number of accesses to data to be stored, and configured to store data, which is larger in the detected number of accesses than a preset value, in a nonvolatile cache memory; and a second storage module configured to detect storable capacity of the nonvolatile cache memory, and configured to detect the number of accesses to each of data stored in the nonvolatile cache memory when the detected capacity is smaller than a preset capacity-value, move the data to a disk cache area provided in a hard disk and used for cache processing, and store the moved data in the disk cache area.

### CROSS REFERENCE TO RELATED APPLICATION(S)

The application is based upon and claims the benefit of priority from Japanese Patent Application No. 2013-137223 filed on Jun. 28, 2013, the entire contents of which are incorporated herein by reference.

### BACKGROUND

1. Field

The present invention relates to a storage device, an electronic apparatus, a control method of the storage device, and a control program for the storage device.

2. Description of the Related Art

In recent years, a storage device called a hybrid hard disk drive (hybrid HDD), which is configured by equipping a hard disk drive (HDD) with a nonvolatile memory such as a flash memory, has been widespread.

The hybrid HDD can be, for example, increased in speed, reduced in electric-power consumption, and improved in performance by increasing the capacity of the nonvolatile memory.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIGS. 1A and 1B are block diagrams illustrating the configuration of a storage device (hybrid HDD) according to an embodiment of the invention.

FIG. 2A is a diagram illustrating a storage operation of a comparative example, and FIG. 2B is a diagram illustrating a storage operation of an embodiment according to the invention.

FIG. 3 is an appearance diagram illustrating an example of an electronic apparatus that accommodates a storage device (hybrid HDD) according to an embodiment of the invention.

FIG. 4 is a flowchart illustrating an operation of a storage device (hybrid HDD) according to an embodiment of the invention.

### BRIEF DESCRIPTION OF THE DRAWINGS

According to one embodiment, a storage device includes: a first storage module configured to detect number of accesses to data to be stored, and configured to store data, which is larger in the detected number of accesses than a preset value, in a nonvolatile cache memory; and a second storage module configured to detect storable capacity of the nonvolatile cache memory, and configured to detect the number of accesses to each of data stored in the nonvolatile cache memory when the detected capacity is smaller than a preset capacity-value, move the data to a disk cache area provided in a hard disk and used for cache processing, and store the moved data in the disk cache area.

Hereinafter, an embodiment of the invention is described with reference to the accompanying-drawings.

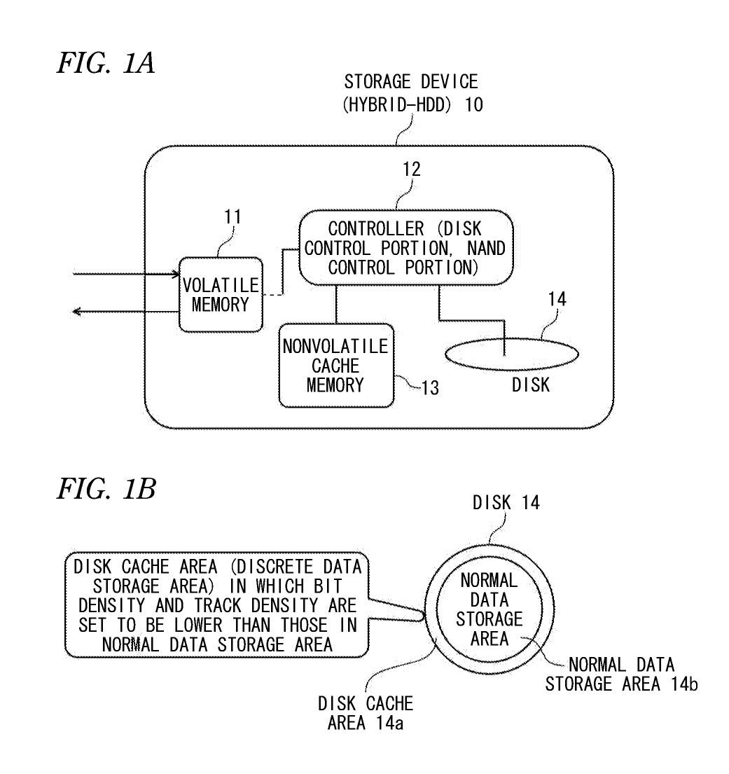

FIGS. 1A and 1B are block diagrams illustrating the configuration of a storage device (hybrid HDD) according to the embodiment of the invention.

As illustrated in FIG. 1A, the storage device (hybrid HDD) according to this embodiment includes a volatile memory 11, a controller 12 for performing hard disk control processing and NAND (flash memory) control processing, a nonvolatile cache memory 13 capable of storing data, and a hard disk (disc) 14 also capable of storing data.

The controller 12 controls the volatile memory 11, the nonvolatile cache memory 13, and the hard disk (disc) 14.

The volatile memory 11 is connected to an external device and receives data to be stored in the storage device (hybrid HDD) 10.

The data received by the volatile memory 11 is stored in the nonvolatile cache memory 13 and the hard disk (disk) 14.

Here, the nonvolatile memory 11 is a memory, e.g., a dynamic random access memory (DRAM), which cannot retain information stored therein if electric power is not supplied thereto.

The nonvolatile cache memory 11 is a nonvolatile memory, e.g., a flash memory, used as a cache-memory.

The hard disk (disc) 14 is a disc to which, e.g., a magnetic-storable magnetic material is applied.

The hard disk (disc) 14 used in the storage device (hybrid HDD) 10 according to this embodiment has a configuration illustrated in, e.g., FIG. 1B.

That is, as illustrated in FIG. 1B, the hard disk (disc) 14 used in the storage device (hybrid HDD) 10 according to this embodiment has a disk cache area 14a and a normal data storage area 14b.

Here, the disk cache area 14a is provided on an outermost peripheral data track of the hard disk 14 or a data track close to the outermost periphery of the hard disk 14.

The data tracks provided in the disk cache area 14a are arranged such that a bit density and a track density are lower than those of data tracks in the normal data storage area 14b, respectively.

If the bit density and the track density of data tracks in the normal data storage area 14b are at, e.g., first reference-levels, those of data tracks in the disk cache area 14a are at second reference-values that are lower than the first reference-values, respectively.

Thus, for example, the occurrence of a seek retry, and read/write retries can be reduced by lowering the bit density and the track density of data tracks in the disk cache area 14a. Accordingly, the cache performance of the disk cache area 14a can be improved.

That is, the storage device (hybrid HDD) 10 according to this embodiment includes a first storage module that detects the number of accesses to data to be stored and that stores, in the nonvolatile cache memory 13, the data which is larger in the detected number of accesses thereto than a preset value.

The storage device (hybrid HDD) 10 according to this embodiment includes a second storage module that detects the storable capacity of the nonvolatile cache memory 13 and then detects, if the detected capacity is smaller than a preset capacity-value, the number of accesses to each of the data stored in the nonvolatile cache memory 13, and moves the data which is larger in the detected-number of accesses thereto than a predetermined value to a disk cache area 14a provided in a hard disk 14 and used for cache processing, and stores the moved data in the disk cache area 14a.

This embodiment is adapted such that data which is high in the number of accesses thereto and cannot completely be stored in the nonvolatile cache memory (primary cache) 13 is written to a disk cache area (secondary cache) 14a arranged on, e.g., a data track close to the outermost periphery of the hard disk 14.

This embodiment is adapted to manage accesses to data which is relatively high in the number of accesses thereto and not arranged in the nonvolatile cache memory (primary cache) 13, even when such data is stored in the disk cache area (secondary cache) 14a. Thus the performance of the storage device (hybrid HDD) 10 is restrained from being degraded.

Incidentally, one or more data tracks provided as the disk cache area (secondary cache) 14a, which substantially include the outermost peripheral-track of the disk 14, lower the bit density and the track density.

Consequently, the occurrence of retries is reduced. Thus, the cache performance is improved.

Although it is advisable that the disk cache area (secondary cache) 13 contains one or more data tracks substantially including the outermost peripheral one of the disk 14, the disk cache area 13 is not necessarily configured to contain such data tracks The disk cache area 13 may be configured to contain one or more data tracks substantially provided in an area close to the outermost peripheral-track of the disk 14.

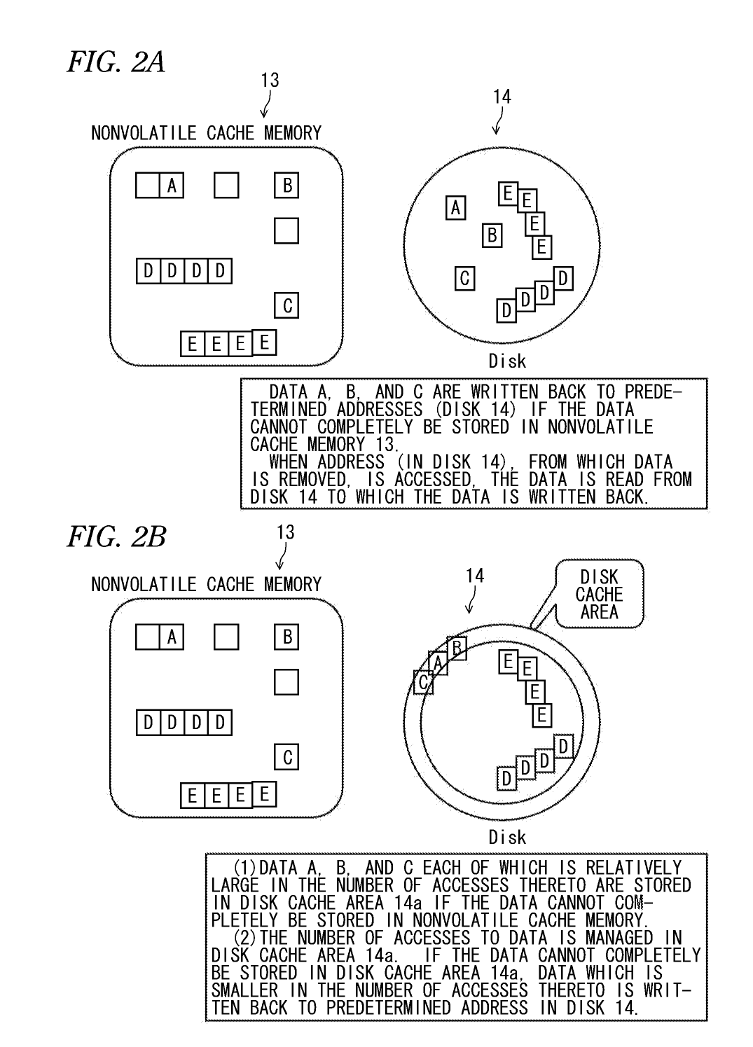

FIG. 2B is a diagram illustrating a storage operation of the storage device (hybrid HDD) according to the embodiment of the invention.

FIG. 2A is a diagram illustrating a storage operation of a comparative example.

Data A, B, and C are data each of which is large in the number of accesses thereto.

As illustrated in FIG. 2A, the data A, B, and C, each of which is relatively large in the number of accesses thereto, are written back to predetermined addresses on the disk 14 if cannot completely be stored in the nonvolatile cache memory 13.

For example, when an address on the disk 14, from which data is removed is accessed, the data is read from the disk 14 to which the data is written back.

FIG. 2B is a diagram illustrating a storage operation of the embodiment of the invention.

Here, the data A, B, and Care data each of which is large in the number of accesses thereto.

As illustrated in FIG. 2B, here, the data A, B, and C, each of which is relatively large in the number of accesses thereto, are stored in the disk cache area 14a, if each of the data A, B, and C cannot completely be stored in the nonvolatile cache memory 13.

The storage device is configured here so that the number of accesses to data in the disk cache area 14a is managed.

The storage device is configured so that data, the number of accesses to which is smaller, is written back to a predetermined address on the disk 14, if the data cannot completely be stored in the disk cache area 14a.

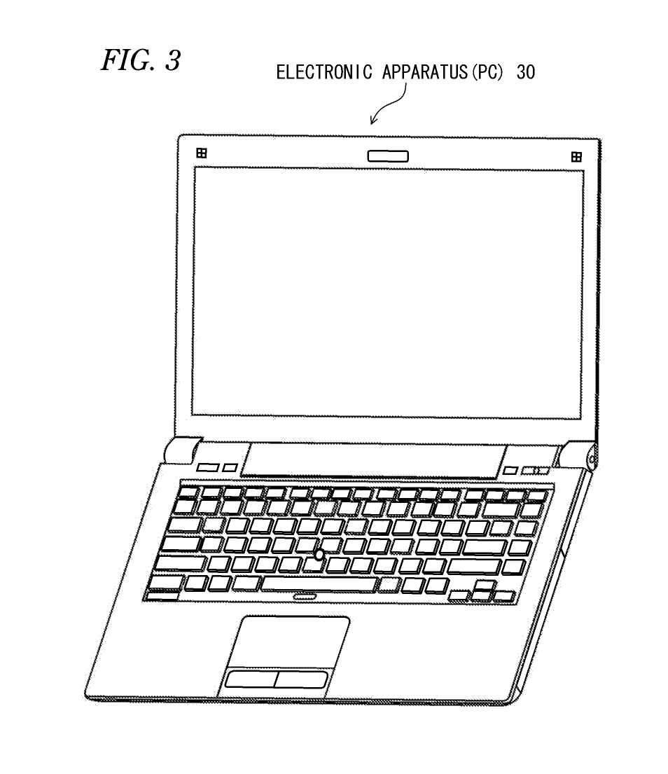

FIG. 3 is an appearance diagram illustrating an example of an electronic apparatus that accommodates the storage device (hybrid HDD) 10 according to the embodiment of the invention.

The storage device (hybrid HDD) 10 according to the embodiment is accommodated in, e.g., an electronic apparatus (personal computer (PC)) 30.

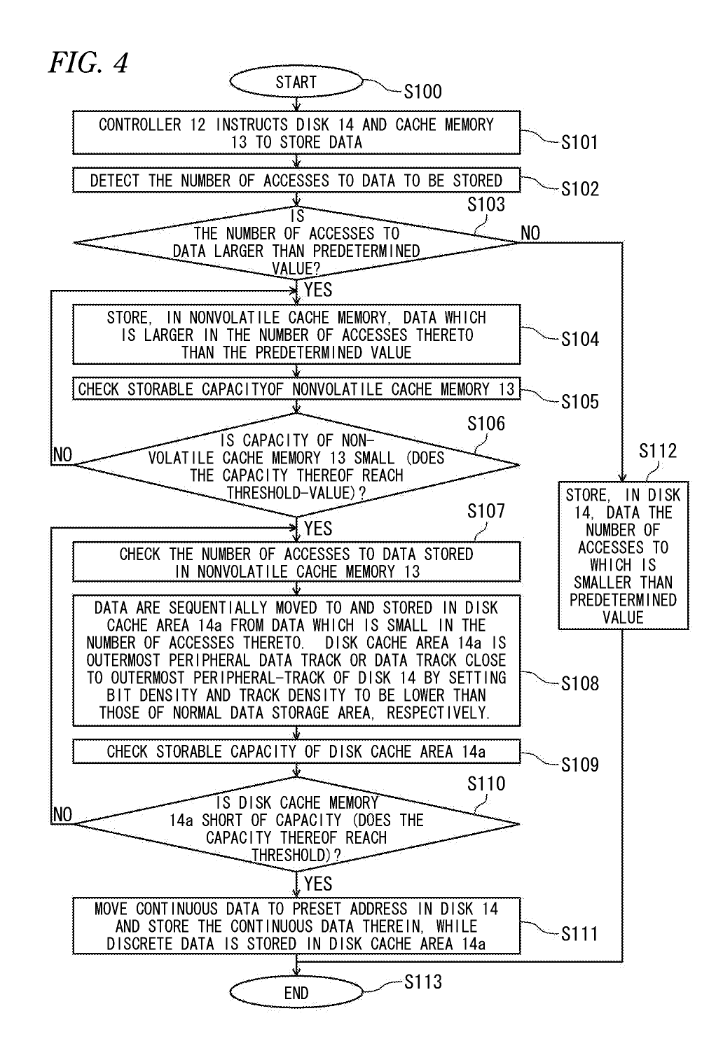

FIG. 4 is a flowchart illustrating an operation of the storage device (hybrid HDD) 10 according to the embodiment.

Step S100 is a start step in this operation. Next, the operation proceeds to step S101.

Step S101 is a step in which the controller 12 of the storage device (hybrid HDD) 10 instructs the disk 14 and the cache memory 13 to store data. Then, the operation proceeds to step S102.

Step S102 is a step in which the number of accesses to data to be stored is detected. Next, the operation proceeds to step S103.

Step S103 is a step in which it is detected whether the number of accesses to data to be stored is larger than a predetermined value preliminarily set. If it is detected that the number of accesses to data to be stored is larger than the predetermined value (Yes in step S103), the operation proceeds to step S104 If it is not detected that the number of accesses to data to be stored is larger than the predetermined value (No in step S103), the operation proceeds to step S112.

Step S104 is a step in which data that is larger in the number of accesses thereto than the predetermined value is stored in the nonvolatile cache memory 13. Then, the operation proceeds to step S105.

Step S105 is a step in which the storable capacity of the nonvolatile cache memory 13 is checked. Next, the operation proceeds to step S106.

Step S106 is a step in which it is detected whether the capacity of the nonvolatile cache memory 13 is small, that is, whether the capacity thereof reaches a preset threshold-value. If it is detected that the capacity of the nonvolatile cache memory 13 is small (Yes in step S106), the operation proceeds to step S107. If it is not detected that the capacity of the nonvolatile cache memory 13 is small (No in step S106), the operation proceeds to step S104, and then the above process is repeated.

Step S107 is a step in which the number of accesses to data stored in the nonvolatile cache memory 13 is checked. Then, the operation proceeds to step S108.

Step S108 is a step in which data are moved to the disk cache area 14a and stored therein sequentially from, e.g., data which is small in the number of accesses thereto.

Incidentally, it is desired that the disk cache area 14a contains the outermost peripheral data track of the disk 14 and/or one or more data tracks provided close to the outermost peripheral-track of the disk 14.

It is also desired to arrange such data tracks by setting the arrangement reference-value (second reference-value) of each of the bit density and the track density thereof to be lower than the arrangement reference-value (first reference-value) of each of the bit density and the track density of data tracks stored in the normal data storage area 14b. Next, the operation proceeds to step S109.

Step S109 is a step in which the storable capacity of the disk cache area 14a is checked. Then, the operation proceeds to step S110.

Step S110 is a step in which it is detected whether the disk cache area 14a is short of capacity, that is, whether the capacity of the disk cache area a reaches a preset threshold-value. If it is detected that the disk cache area 14a is short of capacity (Yes in step S110), the operation proceeds to step S111. If it is not detected that the disk cache area 14a is short of capacity (No in step S110), the operation proceeds to step S107, and then, the above process is repeated.

Step S111 is a step in which continuous data is moved to and stored at a preset address in the disk 14, while discrete data is stored in the disk cache area 14a.

Here, the continuous data is data that can be measured using an infinitely divisible measure or continuum. The discreet data is data that doesn't satisfy the requirements of the continuous data. The discreet data is, e.g., data indicating characteristics and attributes, such as gender, and data measured by setting an artificial measure such as 5-stage assessment and measuring based on the set measure. Then, the operation proceeds to step S113.

Step S113 is an end step. Thus, processing here is ended.

That is, the storage device (hybrid HDD) 10 according to this embodiment includes a first storage module that detects the number of accesses to data to be stored and that stores, in the nonvolatile cache memory 13, the data which is larger in the number of accesses thereto than a preset value (see FIG. 1A).

The storage device (hybrid HDD) 10 according to this embodiment includes a second storage module that detects the storable capacity of the nonvolatile cache memory 13, that detects, if the detected capacity is smaller than a preset capacity-value, the number of accesses to each of the data stored in the nonvolatile cache memory 13, that moves the data which is larger in the detected number of accesses thereto than a predetermined value to a disk cache area provided in a hard disk and used for cache processing, and that stores the moved data in the disk cache area (see FIG. 1B).

The disk cache area 14a includes a substantially outermost peripheral data track of the hard disk 14 or a data tracksclose to the outermost peripheral track of the hard disk 14 and is arranged so that each of the bit density and the track density thereof is set according to a low second reference-value (see FIG. 1B).

When the storable capacity of the disk cache area 14a is detected, if the detected storable capacity is lower than a preset value, continuous data is moved to and stored at a preset address in the hard disk 14 (see FIG. 2B).

Data which is smaller in the number of accesses thereto than the preset value is stored in the normal data storage area 14B in the hard disk 14 (see FIG. 4).

The storage device 10 is a hybrid HDD including the nonvolatile cache memory 13 and the hard disk 14 (see FIG. 1A).

If data which is large in the number of accesses thereto cannot completely be stored in the nonvolatile cache memory 13, such data is stored in the disk cache area 14b.

The number of accesses to data in the disk cache area 14a is managed. If the data cannot completely be stored in the disk cache area 14a, data which is smaller in the number of accesses thereto is written back to the hard disk 14.

An electronic apparatus according to the embodiment includes a casing. The storage device (hybrid HDD) 10 is housed in the casing.

That is, in the storage device (hybrid HDD) 10 according to this embodiment, data which is large in the number of accesses thereto is stored in the nonvolatile cache memory 13.

If the disk cache area 14a is short of capacity, data is moved to a disk cache (disk cache area 14a) from data which is small in the number of accesses thereto.

It is desired that this data movement is performed on an area set by being assigned to the outermost peripheral-track of the hard disk 14 so that data accesses to such an area can be performed at high speed, and that cache performance can be brought out to the maximum extent from such an area.

According to this embodiment, the number of accesses to data is managed even in the disk cache area 14a. If the disk cache (disk cache area 14a) is short of capacity, data is moved to a predetermined address in the hard disk 14 so that degradation in the performance is minimized.

When data is moved, continuous data is stored at a predetermined address in the hard disk 14, whereas discrete data is stored in the disk cache (disk cache area 14a).

According to this embodiment, the disk cache (disk cache area 14a) maybe assigned to an area configured in the hard disk 14 such that the bit density and the track density are low and that a retry is hard to occur.

Consequently, according to this embodiment, when data is moved from, e.g., the nonvolatile cache memory 13 to the disk cache (disk cache area 14a), the data is separated into continuous data and discrete data which are then moved. Thus, even when a reaccess to discrete data is performed, degradation in the performance can be reduced.

In addition, an area in which the bit density and the track density of a data track are low is assigned to the disk cache (disk cache area 14a). Thus, for example, a seek retry and read/write retries are made to hardly occur.

Therefore, the cache performance of the storage device (hybrid HDD) 10 can be improved.

On the other hand, for example, the disk cache (disk cache area 14a) is inhibited from storing continuous data. Thus, the capacity of the disk cache area 14a can be reduced.

Consequently, the disk cache area 14a in which the bit density and the track density of data tracks are lowered can be increased.

With the above configuration, according to this embodiment, a storage device (hybrid HDD) configured to restrain a cost rise and to improve the performance can be provided.

The procedure of the control process according to the above embodiments can fully be performed by software. Therefore, advantages similar to those of the above embodiments can easily be achieved by only installing a program that performs the procedure of the control process in an ordinary computer through a computer-readable storage medium stored with the program and running the program.

Incidentally, the invention is not limited to the above embodiments themselves. In an implementing stage, the invention may be embodied while variously modifying components without departing from the spirit and scope of the invention.

Various embodiments of the invention can be implemented by appropriately combining plural components disclosed in the above embodiment.

For example, some components may be deleted from all components described in the above embodiment. Further, the components in different embodiments may appropriately be combined with one another.

What is claimed is:

1. A storage device comprising:
a first storage configured to detect number of accesses to data to be stored, and configured to store first data, which has a larger detected number of accesses than a first number, in a nonvolatile cache memory; and
a second storage configured to detect a storable capacity of the nonvolatile cache memory, and configured to detect the number of accesses to second data stored in the nonvolatile cache memory when the detected capacity is smaller than a first capacity-value, move the second data to a disk cache area provided in a hard disk and used for cache processing, and store the second data in the disk cache area.

2. The storage device according to claim 1, wherein:
the disk cache area comprises an outermost peripheral data track of the hard disk or a data track close to the outermost peripheral data track of the hard disk; and
a bit density and a track density of the disk cache area are at low reference-values.

3. The storage device according to claim 1, wherein:
a storable capacity of the disk cache area is detected; and
continuous data is moved and stored at a first address in the hard disk when the storable capacity is smaller than a second value.

4. The storage device according to claim 1, wherein
third data, which has a smaller number of accesses than the first number, is stored in the hard disk.

5. The storage device according to claim 1, wherein
the storage device is a hybrid hard disk drive comprising the nonvolatile cache memory and the hard disk.

6. The storage device according to claim 1, wherein
fourth data, which has the larger number of accesses and is not completely stored in the nonvolatile cache memory, is stored in the disk cache area.

7. The storage device according to claim 1, wherein:
the number of accesses to the data is managed in the disk cache area; and
fifth data, which has the smaller number of accesses, is written back to the hard disk when the fifth data cannot completely be stored in the disk cache area.

8. An electronic apparatus comprising:
a casing; and
a storage device comprising:
a first storage configured to detect a number of accesses to data to be stored, and configured to store first data, which has a larger detected number of accesses than a first number, in a nonvolatile cache memory; and
a second storage configured to detect a storable capacity of the nonvolatile cache memory, and configured to detect the number of accesses to second data stored in the nonvolatile cache memory when the detected capacity is smaller than a first capacity-value, move the second data to a disk cache area provided in a hard disk and used for cache processing, and store the second data in the disk cache area, wherein
the storage device is accommodated in the casing.

9. A storage-device control method for controlling a storage device, comprising:
detecting a number of accesses to data to be stored and storing first data, which has a larger detected number of accesses than a first number, in a nonvolatile cache memory;
detecting a storable capacity of the nonvolatile cache memory, and detecting the number of accesses to second data stored in the nonvolatile cache memory when the detected capacity is smaller than a first capacity-value; and
moving the second data to a disk cache area provided a hard disk and used for cache processing, and storing the second data in the disk cache area.

10. A recording medium configured to store a control program for causing a computer to perform a control operation comprising:
detecting a number of accesses to data to be stored and storing first data, which has a larger detected number of accesses than a first number, in a nonvolatile cache memory;
detecting a storable capacity of the nonvolatile cache memory, and detecting the number of accesses to second data stored in the nonvolatile cache memory when the detected capacity is smaller than a first capacity-value; and
moving the second data to a disk cache area provided in a hard disk and used for cache processing, and storing the second data in the disk cache area.
